(19) United States
(12) Patent Application Publication
(10) Pub. No.: US 2006/0237501 A1
(43) Pub. Date: Oct. 26, 2006

(54) Roof carrier for fishing rods

(76) Inventor: Raul C. Gonzalez, Houston, TX (US)

Correspondence Address: John R. Casperson, PO Box 2174, Friendswood, TX, 77549, US

(21) Appl. No.: 11/401,771

(22) Filed: Apr. 11, 2006

Related U.S. Application Data
(60) Provisional application No. 60/671,926, filed on Apr. 15, 2005.

(51) Int. Cl. B60R 9/00

(52) U.S. Cl. 224/325; 224/922

(57) ABSTRACT

A roof top carrier for fishing rods is described wherein the rods are carried by a pair of cross-members extending across the roof of the vehicle. The back cross-member is provided with boreholes which carry the handles of the rods, while the front cross-member is provided with notches which receive the flexible rod ends. The cross-members are mounted on pedestals to prevent the fishing reels attached to the rods from contacting the roof of the vehicle, and are preferably secured to the vehicle by straps which are connected to the vehicle door or window frames by clasps or hooks.

### CROSS REFERENCES TO RELATED APPLICATIONS

This application claims the benefit of U.S. Provisional Application No. 60/671,926 filed Apr. 15, 2005, the disclosure of which is herein incorporated by reference.

### BACKGROUND OF THE INVENTION

In one aspect, the invention relates to an apparatus which can be removably installed on the roof of an automobile to provide a mounting structure for securely carrying fishing rods on the roof.

Fishing rods, especially long rods, are difficult to transport by automobile. They are too long to fit inside of the car, and subject to being damaged by other vehicles if left to protrude out of a window.

An apparatus to carry fishing rods on the roof of the vehicle in a manner to avoid their being damaged by impact against each other or with other objects would be very desirable.

### SUMMARY OF THE INVENTION

In accordance with one embodiment of the invention, there is provided an apparatus for carrying fishing rods on a vehicle roof. The apparatus comprises a first longitudinally elongated cross-member and a second longitudinally elongated cross-member. Each of the first and the second longitudinally elongated cross-members has an upper surface, a lower surface, a front surface, a back surface, a first end, and a second end. At least two mounting pedestals are mounted at spaced apart positions on the lower surface of each of the longitudinally elongated cross-members. These pedestals extend transversely from the longitudinally elongated cross-members for supporting the first and second longitudinally elongated cross-members in generally parallel fashion to extend transversely across the motor vehicle roof. The mounting pedestals maintain the longitudinally elongated cross-members spaced apart from the vehicle roof, preferably in an amount adequate to prevent any fishing reels attached to rods carried by the device from contacting the roof. The first longitudinally elongated cross-member defines a plurality of boreholes extending transversely therethrough from the front surface to the back surface for receiving fishing rod bottom ends. The second longitudinally elongated cross-member defines a plurality of notches formed in the upper surface extending transversely across the upper surface from the front surface to the back surface for receiving the fishing rod top ends. When the device is secured to the automobile roof, a plurality of fishing rods can be safely transported.

### BRIEF DESCRIPTION OF THE DRAWINGS

FIG. 1 pictorially illustrates one embodiment of the present invention.

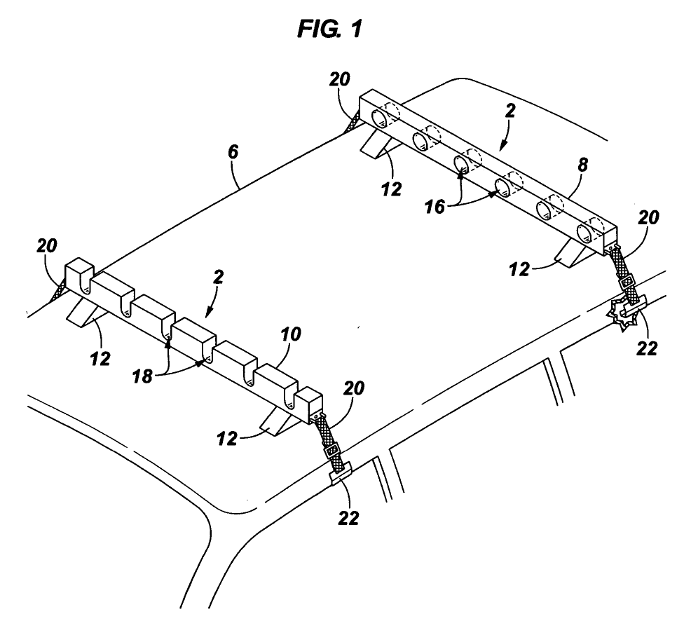

FIG. 2 pictorially illustrates a preferred embodiment of the invention employing the features of FIG. 1.

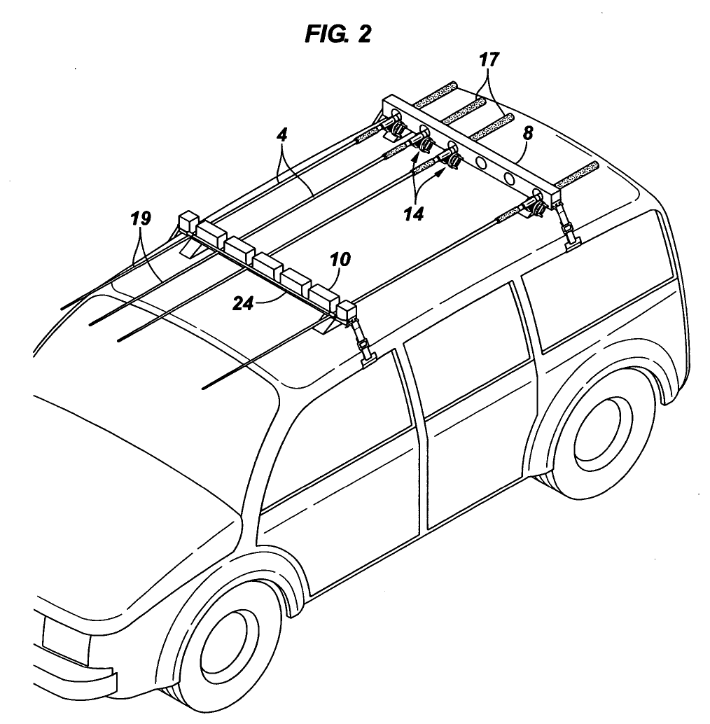

### DETAILED DESCRIPTION OF THE INVENTION

In accordance with one embodiment of the invention, there is provided an apparatus 2 for carrying fishing rods 4 on a vehicle roof 6. The apparatus comprises a first longitudinally elongated cross-member 8 and a second longitudinally elongated cross-member 10. Each of the first and the second longitudinally elongated cross-members has an upper surf-ace, a lower surface, a front surface, a back surface, a first end, and a second end. At least two mounting pedestals 12 are mounted at spaced apart positions on the lower surface of each of the longitudinally elongated cross-members. These pedestals extend transversely from the longitudinally elongated cross-members for supporting the first and second longitudinally elongated cross-members in generally parallel fashion to extend transversely across the motor vehicle roof. The mounting pedestals maintain the longitudinally elongated cross-members spaced apart from the vehicle roof, preferably in an amount adequate to prevent any fishing reels 14 attached to rods carried by the device from contacting the roof. The first longitudinally elongated cross-member defines a plurality of boreholes 16 extending transversely therethrough from the front surface to the back surface for receiving fishing rod bottom ends 17. The second longitudinally elongated cross-member defines a plurality of notches 18 formed in the upper surface extending transversely across the upper surface from the front surface to the back surface for receiving the fishing rod top ends 19. When the device is secured to the automobile roof, a plurality of fishing rods can be safely transported.

Preferably, each longitudinally elongated cross-member has a width as measured between the front face and the back face and each mounting pedestal has a base end having a length as measured in a direction parallel to the width of the longitudinally elongated cross-member which is greater than the width, to provide the longitudinally elongated cross-member with lateral stability against tipping in the directions of the front face and the back face.

The number of boreholes in the first longitudinally elongated cross-member is preferably equal to the number of notches in the second longitudinally elongated cross-member, so that the rods are carried parallel to the longitudinal axis of the vehicle, to minimize wind resistance.

The longitudinally elongated cross-members are preferably secured to the vehicle by straps 20. Preferably, a strap is attached to each end of the first longitudinally elongated cross-member and to each end of the second longitudinally elongated cross-member for securing each cross-member to an automobile roof. Eyes can be connected to the ends of the cross members to serve this purpose. The straps can connect to each other via a buckle (not shown) in the vehicle compartment. Preferably, however, each strap has a first end connected to an end of an elongated cross-member and a second end carrying a fastener 22 for such as a clasp for hooking to a downwardly facing ledge positioned near a periphery of an automobile roof. For example, the clasps may be hooked to a ledge formed adjacent to a door or window of the automobile. The straps are preferably fixedly adjustable in length, such as by a buckle, to secure the device to the vehicle roof.

The rods are partially secured from wind caused by movement of the vehicle by the boreholes. Wind blowing against the rods causes the reels to bottom against the first longitudinally elongated cross-member. Preferably, however, the rods are further secured by a tie-down 24 extending from a first end of the second elongated cross-member to the second end of the second elongated cross-member for retaining the fishing rod top ends in the notches. A stretchable band such as a rubber bungee, is suitable. It can be secured by its ends to the strap eyes on the ends of the cross member.

The first elongated cross-member, the second elongated cross-member, and the pedestals are preferably formed from a material which will not mar the vehicle roof or chaff the top ends of the fishing rods. For example, thermoplastic or rubbery polymers are believed suitable.

In use, the apparatus is mounted to an automobile having a roof. The roof has a forward portion and a rearward portion. The first longitudinally elongated cross-member is mounted across the rearward portion of the roof, and the second longitudinally elongated cross-member is mounted across the forward portion of the roof The straps provided secure these elements to the roof. The bungee retains the rods in the notches. Rearward movement of the rods is prevented by the reels bottoming on the cross cross-member. Forward movement of the rods is prevented by the wind and by the rod eyes bottoming on the front cross cross-member.

While certain preferred embodiments of the invention are described herein, the invention is not to be construed as being so limited, except to the extent that such limitations are found in the claims.

What is claimed is:

1. Apparatus comprising
a first longitudinally elongated cross-member and a second longitudinally elongated cross-member;
each of said first and said second longitudinally elongated cross-member having an upper surface, a lower surface, a front surface, a back surface, a first end, and a second end and further having at least two mounting pedestals mounted at spaced apart positions to the lower surface thereof and extending transversely therefrom for supporting the first and second longitudinally elongated cross-members in generally parallel fashion extending transversely across a motor vehicle roof, said mounting pedestals maintaining the longitudinally elongated cross-members spaced apart from the vehicle roof;
wherein said first longitudinally elongated cross-member defines a plurality of boreholes extending transversely therethrough from the front surface to the back surface for receiving fishing rod bottom ends,
wherein said second longitudinally elongated cross-member defines a plurality of notches formed in the upper surface extending transversely across the upper surface from the front surface to the back surface for receiving fishing rod top ends.

2. Apparatus as in claim 1 wherein
each longitudinally elongated cross-member has a width as measured between the front face and the back face and each mounting pedestal has a base end having a length as measured in a direction parallel to the width of the longitudinally elongated cross-member which is greater than said width, to provide the longitudinally elongated cross-member with lateral stability against tipping in the directions of the front face and the back face.

3. Apparatus as in claim 2 wherein the number of boreholes in the first longitudinally elongated cross-member is equal to the number of notches in the second longitudinally elongated cross-member.

4. Apparatus as in claim 3 further comprising a strap attached to each end of the first longitudinally elongated cross-member and to each end of the second longitudinally elongated cross-member for securing each cross-member to an automobile roof.

5. Apparatus as in claim 5 wherein each strap has a first end connected to an end of an elongated cross-member and a second end carrying a fastener for hooking to a downwardly facing ledge positioned near a periphery of an automobile roof.

6. Apparatus as in claim 5 further comprising
a tie-down extending from a first end of the second elongated cross-member to the second end of the second elongated cross-member for retaining fishing rod top ends in the notches.

7. Apparatus as in claim 6 wherein the first elongated cross-member, the second elongated cross-member, and the pedestals are formed from thermoplastic.

8. Apparatus as in claim 6 wherein the first elongated cross-member, the second elongated cross-member and the pedestals are formed from rubbery polymer.

9. Apparatus as in claim 6 wherein the tie-down comprises a stretchable band.

10. Apparatus as in claim 6, further comprising, in combination,
an automobile having a roof, said roof having a forward portion and a rearward portion,
wherein the first longitudinally elongated cross-member is mounted across a rearward portion of the roof, and
wherein the second longitudinally elongated cross-member is mounted across a forward portion of the roof.

11. Apparatus as in claim 10 wherein the fasteners are hooked to a ledge formed adjacent a door or window.
